(19) United States
(12) Patent Application Publication
(10) Pub. No.: US 2025/0202292 A1
(43) Pub. Date: Jun. 19, 2025

(54) Method for Producing a Rotor Bandage for a Rotor, and Rotor

(71) Applicant: Bayerische Motoren Werke Aktiengesellschaft, Muenchen (DE)

(72) Inventors: Thomas BECKER, Dorfen (DE); Korbinian KOENIG-PETERMAIER, Muenchen (DE); Robert SCHMIDT, Muenchen (DE)

(21) Appl. No.: 18/847,885

(22) PCT Filed: Apr. 24, 2023
(86) PCT No.: PCT/EP2023/060629

§ 371 Date: Sep. 17, 2024

(30) Foreign Application Priority Data
May 16, 2022 (DE) 10 2022 112 183.6

(51) Int. Cl. H02K 1/04; H02K 1/28; H02K 15/121

(52) U.S. Cl. CPC H02K 1/04; H02K 1/28; H02K 15/121

(57) ABSTRACT

A process for producing a rotor bandage for a rotor of an electric machine includes winding a composite material onto a carrier so as to form and create a rotor bandage, and applying a magnetizable material to the composite material so as to create a magnetizable layer on the composite material.

### BACKGROUND AND SUMMARY

The present invention relates to a process for producing a rotor bandage for a rotor of an electrical machine, and to a rotor.

It is known from the prior art (cf., for example, US 2014/0117742 A1), that rotors of electrical machines can be equipped with what are called rotor bandages in order, for example, to increase the speed resistance thereof. Such bandages are situated on the laminated rotor stack and hence within the magnetic airgap of the electrical machines. When electrically conductive materials are used, changes in flux can result in eddy currents with corresponding joule heat losses. For that reason, preference is given to materials having minimum electrical conductivity, for example fiber composites. These are additionally notable for high mechanical strength. A problem is that the use thereof leads to an enlarged magnetically active airgap.

It is therefore an object of the present invention to specify a process for producing a rotor bandage and a rotor, wherein the known approaches and methods are to be further developed and optimized.

This object is achieved by a process and by a rotor according to the present disclosure. Further advantages and features will also be apparent from the description and the appended figures.

According to the invention, a process for producing a rotor bandage for a rotor of an electrical machine comprises the steps of:
wrapping a composite material onto a carrier to form and create a rotor bandage;
applying a magnetizable material to the composite material to create a magnetizable layer or ply, preferably several, on the composite material.

The composite material comprises a base material, preferably a fiber material, and a matrix material. The composite material, in strip or sheet form, for example, is wrapped on to the carrier to form and create the rotor bandage. There is no restriction in the present context with regard to the wrapping scheme. What is crucial is that the magnetizable material is applied to the composite material for creation of at least one magnetizable layer on the composite material. It is thus appropriately possible to produce a rotor bandage having one or more magnetizable layers, whether in radial and/or in axial direction (based on a rotor axis). Such layers or plies in the present context are appropriately formed or shaped from the magnetizable material. The magnetizable material in the present context is not a (constituent) part of the composite material but forms separate, isolated sections or regions; cf. the aforementioned layers or plies. Viewed radially to a rotor axis, it is possible to provide or create multiple magnetizable layers of this kind. In addition, several magnetizable layers of this kind are created along the rotor axis, i.e. in axial direction. The magnetizable layers are preferably not formed continuously in axial direction but, for example, merely in sections, such that the occurrence of leakage fluxes can be effectively prevented.

A rotor bandage produced in this way appropriately has a permeability >1. It is thus possible to partly compensate for the additional space demand of the rotor bandage. By means of a rotor bandage produced as proposed, the flux loss of the corresponding electrical machine is lower than in the case of a non-magnetically conductive bandage. In the case of a magnetically nonconductive rotor bandage, it would be necessary to increase the excitation of the rotor accordingly, which results in occurrence of higher rotating masses (increase in magnet mass) and the need to make the bandage correspondingly thicker. A magnetically conductive rotor bandage can thus reduce rotating masses and hence be made thinner. Moreover, the costs of the corresponding rotor can be decreased by the reduction in the use of magnet material. It has been found that magnetic flux in radial direction is much higher in the case of application of the magnetizable material on the composite material for creation of the magnetizable layer than if magnetizable material is mixed directly with the matrix material.

The fiber material, in one embodiment, is one or more fiber bundles or one or more fiber strands. Preferred fiber materials are glass fibers, carbon fibers or aramid fibers, although this enumeration should not be considered to be exhaustive. The matrix material, in preferred embodiments, is a resin. Thermoplastics or thermosets are typically used here.

In one embodiment, the composite material is a prepreg material. Prepregs are semifinished textile fiber matrix products that have been preimpregnated with reactive resins.

Alternatively, the process comprises the steps of:
providing a base material, especially a fiber material;
applying matrix material to the base material to create the composite material.

First of all, in this embodiment, “dry” fiber material is thus provided, which first has to be impregnated with the matrix material.

In one embodiment, the carrier is a rotating spike or a rotor of an electrical machine. Appropriately, the rotor bandage can thus be produced separately and disposed subsequently on a rotor, especially on a laminated stack of a rotor. Alternatively, the rotor bandage may also be created directly on the rotor or on the laminated rotor stack.

In one embodiment, the rotor bandage has a length which, viewed along a rotor axis, corresponds essentially to the length of the rotor or the laminated stack thereof. Alternatively, the rotor bandage may also be formed from individual segments that are disposed on the rotor or laminated stack along the rotor axis.

In one embodiment, the magnetizable material comprises or consists of at least one of the following constituents: iron, graphite, phosphorus, nickel, an iron-phosphorus alloy, an iron-nickel alloy, molybdenum.

In one embodiment, the material is in powder form or is applied in powder form. Alternatively, the magnetizable material may take the form of metal sheets or metal strips. These are appropriately as thin as possible. The thickness thereof is preferably less than 0.8 mm, especially less than 0.5 mm.

In a preferred embodiment, the base material is a fiber bundle. The process appropriately comprises the steps of:
spreading the fiber bundle;
impregnating the fiber bundle with matrix material;
applying the magnetizable material.

In one embodiment, at the time of applying the magnetizable material, the matrix material is not yet cured. The magnetizable material is thus appropriately embedded into the composite material. This also achieves the effect that very thin rotor bandages can be created. The fiber bundle is spread out using a suitable apparatus or spreading station. Such apparatuses are known in the field of wet winding technology (also filament winding). Appropriately, such apparatuses have, for example, comblike devices designed to spread out fiber bundles or fiber strands. The fiber strand or fiber bundle at first has a starting width and a starting thickness and, after the spreading, is spread to give a strip-shaped fiber strand with greater strip width and greater thickness. Appropriately, the fiber bundles/fiber strands are spread out as far as possible. The layer thickness of a ply should be as thin as possible, such that a maximum powder volume content can be achieved.

In a preferred embodiment, the matrix material is applied by the aforementioned impregnation. The fiber bundle is transported here, for example, through a suitable dip bath.

In one embodiment, the process comprises the step of:
applying the magnetizable material by coating, especially by impregnating, dipping, spraying or painting.

As already mentioned, the magnetizable material, in one embodiment, is in pulverulent form. Such a powder can be applied, for example, by impregnating/dipping or spraying. In one embodiment, the composite material is transported through a “curtain” of magnetizable material. The magnetizable, especially pulverulent, material thus falls onto the composite material and adheres thereon. Alternatively, it is also possible to work with dip baths or with conventional automated painting methods if the magnetizable material is in pulverulent and/or else liquid form. Manual painting, for example application with a brush, is also possible and effective.

In one embodiment, the process comprises the step of:
applying magnetizable material before, during and/or after the winding.

The magnetizable material can appropriately be applied at various junctures during production. In one embodiment, the magnetizable material is applied before the actual winding operation. Alternatively or additionally, the magnetizable material is applied when the composite material has already been wrapped onto at least some regions of the carrier. The magnetizable material may also be applied when a layer or ply of the rotor bandage has already been wrapped at least partly or completely, etc. An extremely large number of degrees of freedom therefore arise with regard to the configuration of the magnetizable layers. The configuration of the magnetizable layer(s) may advantageously be oriented to the shape, position and orientation of the magnets embedded in the main rotor body.

In one embodiment, the process comprises the step of:
applying magnetizable material on the carrier.

It is thus possible to create a rotor bandage wherein the innermost ply takes the form of a magnetizable layer at least in regions or sections, or appropriately comprises two or more magnetizable layers. As already mentioned, the magnetizable layer(s) preferably do(es) not run continuously along the rotor axis. Instead, a multitude of magnetizable layers is provided along the rotor axis, which are not directly coherent, in order to prevent leakage flux in axial direction.

In one embodiment, the process comprises the step of:
removing excess magnetizable material by rotating the carrier.

It is preferably possible by rotating the carrier, for example also via adjustment of the speed of rotation, to automatically “spin off” excess magnetizable material via centrifugal forces. Alternatively, it is possible to work with strippers or the like in order to influence the thickness of the magnetizable layer(s).

In one embodiment, the process comprises the step of:
creating a multitude of magnetizable layers in radial direction.

It has already been mentioned that it may be appropriate to provide more than one magnetizable layer in radial direction. The thickness of a magnetizable layer, in preferred embodiments, may be between about 0.1 and 0.5 mm.

The invention also relates to a rotor comprising at least one rotor bandage produced by the process of the invention, where the rotor bandage has at least one magnetizable layer. The advantages and features that have been mentioned in connection with the rotor are equally applicable to the process, and vice versa.

In a preferred embodiment, the rotor is the rotor for a permanently excited synchronous machine. The rotor comprises a main rotor body comprising a laminated rotor stack. The laminated rotor stack has several receptacles for arrangement of permanent magnets. At least one rotor bandage is arranged around the circumference of the laminated rotor stack. In one embodiment, the rotor bandage has a length that covers the main rotor body along the rotor axis. Alternatively, the rotor bandage may have several segments in a mutually adjoining arrangement on the main rotor body. This can facilitate assembly.

In one embodiment, the rotor bandage has been created separately and disposed subsequently on the rotor or the main rotor body. Alternatively, the rotor bandage may also be created directly on the rotor.

The magnetizable layer is, or the layers are, a two-dimensional layer or ply formed within and/or inside and/or outside the rotor bandage. In a preferred embodiment, the two-dimensional layers are formed on the sheet- or strip-shaped composite material along the length thereof, over the full area or intermittently, on one or both sides. Depending on the wrapping scheme, the result is thus a more or less irregular distribution of the layers or plies of the magnetizable material.

Further advantages and features will be apparent from the description of an embodiment of the process and of a rotor which follows, with reference to the appended figures.

### BRIEF DESCRIPTION OF THE DRAWINGS

FIG. 1 a schematic diagram for illustration of one embodiment of the process of the invention;

FIG. 2 a schematic view of one embodiment of a rotor of the invention and a corresponding detail diagram.

### DETAILED DESCRIPTION OF THE DRAWINGS

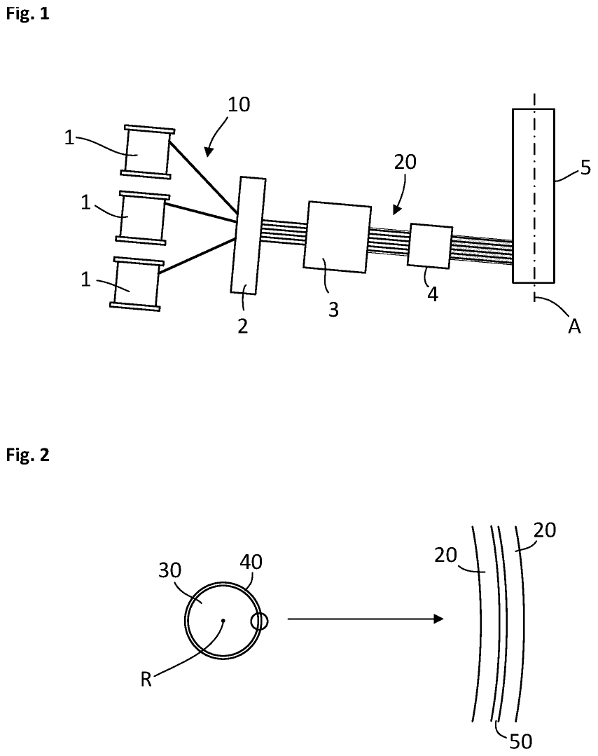

FIG. 1 shows a schematic of multiple spools 1 around which base material/fiber material 10 has been wrapped. The latter is unwrapped and fed to a spreading device 2. The fiber bundles are spread out here, and the filaments thereof are singularized. Thereafter, they are passed through a dip bath 3, where the base material 10 is impregnated with a matrix material. The reference numeral 4 symbolizes an apparatus for application of magnetizable material. This is applied to the composite material 20 that has been spread out as broadly as possible. The composite material 20 along with the magnetizable material is then wound onto a carrier 5. The carrier 5 is rotated here about an axis of rotation A. The carrier 5 can appropriately also be moved along the axis of rotation A. The carrier 5 may be a spike which is used for production of a rotor bandage. Alternatively, the carrier 5 may also directly be a laminated rotor stack of a rotor.

FIG. 2 shows, viewed along a rotor axis R, a rotor 30 with a rotor bandage 40 disposed thereon. The right-hand half of the image shows a detail. It is apparent that the rotor bandage 40 comprises composite material 20 or plies or layers of composite material 20. A magnetizable layer 50 is formed in between. Two or more of these magnetizable layers 50 may be provided in radial direction. The layers of the composite material 20 are appropriately very thin, so as to create “space” for at least one magnetizable layer 50.

### LIST OF REFERENCE NUMERALS

1 spool
2 apparatus for spreading, spreading apparatus
3 dip bath
4 apparatus for application of magnetizable material
5 carrier, spike
10 base material, fiber material
20 composite material
30 rotor
40 (rotor) bandage, sleeve element, reinforcing element
50 magnetizable layer
R rotor axis
A axis of rotation

1-13. (canceled)

14. A process for producing a rotor bandage for a rotor of an electrical machine, comprising:
wrapping a composite material onto a carrier to form and create a rotor bandage; and
applying a magnetizable material to the composite material to create a magnetizable layer on the composite material.

15. The process according to claim 14,
wherein the composite material is a prepreg material, or
wherein the process comprises:
providing a base material comprising a fiber material; and
applying matrix material to the base material to create the composite material.

16. The process according to claim 14,
wherein the carrier is a rotating spike or a rotor of an electrical machine.

17. The process according to claim 14,
wherein the magnetizable material is in pulverulent form.

18. The process according to claim 15,
wherein the base material is a fiber bundle,
the process comprising:
spreading the fiber bundle;
impregnating the fiber bundle with matrix material; and
applying the magnetizable material.

19. The process according to claim 14, comprising:
applying the magnetizable material by coating, wherein the coating comprises impregnating/dipping, spraying, or painting.

20. The process according to claim 14, comprising:
applying magnetizable material before, during, and/or after the wrapping.

21. The process according to claim 14, comprising:
applying magnetizable material to the carrier.

22. The process according to claim 14, comprising:
removing excess magnetizable material by rotating the carrier.

23. The process according to claim 14, comprising:
creating a multitude of magnetizable layers in a radial direction.

24. A rotor comprising:
at least one rotor bandage produced according to the process according to claim 14,
wherein the rotor bandage has at least one magnetizable layer.

25. The rotor according to claim 24,
wherein the rotor bandage has been produced separately and disposed on the rotor.

26. The rotor according to claim 24,
wherein the rotor bandage has been produced on the rotor.
